(19) United States
(12) Patent Application Publication
(10) Pub. No.: US 2016/0102848 A1
(43) Pub. Date: Apr. 14, 2016

(54) ADAPTER FOR LED MODULES OF THE PACKAGE/ARRAY TYPE

(71) Applicant: A.A.G. STUCCHI S.R.L., Olginate (IT)

(72) Inventor: Antonietta STUCCHI, Olginate (IT)

(73) Assignee: A.A.G. STUCCHI S.R.L., Olginate (IT)

(21) Appl. No.: 14/893,363

(22) PCT Filed: Apr. 10, 2014
(86) PCT No.: PCT/EP2014/057249

§ 371 Date: Nov. 23, 2015

(30) Foreign Application Priority Data
May 24, 2013 (IT) MI2013A000843

(51) Int. Cl. F21V 19/00; F21V 29/70

(52) U.S. Cl. CPC F21V 19/004; F21V 19/0055; F21V 29/70; F21V 19/0035; F21Y 2101/02

(57) ABSTRACT

An adapter for LED modules of the package/array type, comprising an adapter body that is provided with a cavity adapted to accommodate an LED module of the package/array type and is associable with a heat sink; a heat dissipation interface element can be inserted between the LED module and the heat sink; the adapter comprising elements for retaining the LED module, which are adapted to engage the face of the LED module that is directed toward the heat sink, in order to retain the LED module within the cavity.

The present invention relates to an adapter for LED modules of the package/array type.

As is known, LED modules of the package/array type are commercially available which have different dimensions, shapes and volumes and need suitable adapters in order to be coupled to heat sinks and to be connected electrically to the power supply circuit.

Such adapters are used to fix an LED module of the package/array to a heat sink, generally with the interposition of a heat dissipation interface element (“TIM” in acronym) between the face of the LED module that is directed toward the heat sink and the heat sink itself. The adapters comprise generally a pair or more of through holes, adapted to receive a pair or more of screws, by means of which the adapter is fixed to the heat sink, keeping the LED module in position.

The fixing of said adapters of the known type to the heat sink, however, is particularly difficult, since it requires a number of manual operations that are subject to frequent errors.

In particular, the heat dissipation interface element (TIM), which is generally constituted by an adhesive material, or optionally by grease or the like, is applied to the LED module or to the heat sink; then the LED module is arranged on the heat sink and then the adapter is superimposed on the LED module and oriented until the fixing holes present in the heat sink are centered with the ones of the adapter and then the screws are tightened.

However, particularly in the case in which the heat dissipation interface is of the adhesive type, if during the fixing step of the LED module it is not possible to perform a correct centering among the several components at the first attempt, it is then very complicated, as well as expensive, to detach the LED module and the other components in order to repeat the operation correctly. Similar problems occur also when the heat dissipation interface is constituted by grease or the like, since errors in the positioning of the components invalidate the uniform distribution of the grease, where required. The centering of the LED module is particularly difficult to achieve, because the LED module can move horizontally during the assembly step and therefore can lose its centering with respect to the fixing holes and/or with respect to the cavity in which it is to be arranged.

Therefore, adapters of the known type do not solve the problems linked to the difficulty of orienting the several components in a narrow space and to the fact that the heat dissipation interface might be spoiled and might lose effectiveness.

A further drawback of such adapters of the known type resides in that they have a mechanical retention of the LED modules that is scarcely stable and reliable over time.

Another drawback of such adapters of the known type resides in that they are not capable of keeping the LED module in position, i.e., accommodated in a cavity formed inside the adapter itself, when they are directed downward, i.e., toward the heat sink, and not yet fixed to it.

The aim of the present invention is to provide an adapter for LED modules that obviates the drawbacks and overcomes the limitations of the background art, ensuring easier fixing of the LED module to the heat sink, particularly during the assembly step, as well as an improvement in the reliability and safety of the fixing over time.

Another object of the invention is to provide an adapter for LED modules that is easy to provide and economically competitive if compared with the background art.

This aim and these and other objects that will become better apparent hereinafter are achieved by an adapter for LED modules of the package/array type, comprising an adapter body provided with a cavity adapted to accommodate an LED module of the package/array type, and associable with a heat sink, a heat dissipation interface element being insertable between said LED module and said heat sink, characterized in that it comprises means for retaining said LED module, which are adapted to engage the face of said LED module that is directed toward said heat sink, in order to retain said LED module within said cavity.

Further characteristics and advantages will become better apparent from the description of a preferred but not exclusive embodiment of an adapter for LED modules of the package/array type, illustrated by way of non-limiting example with the aid of the accompanying drawings, wherein:

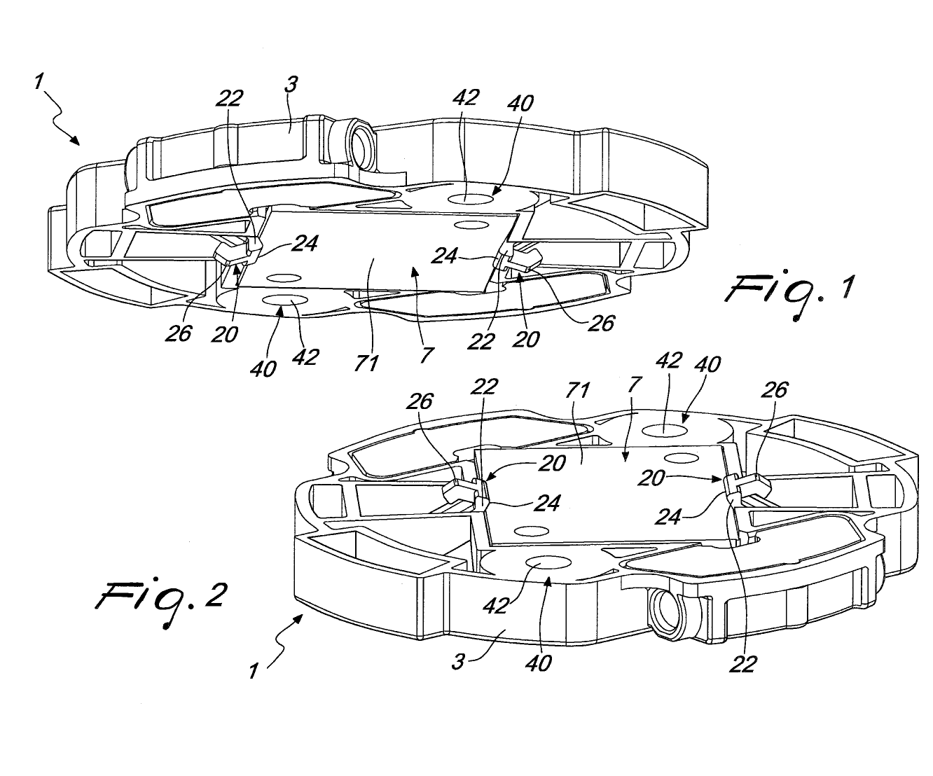

FIG. 1 is a perspective view from below of an embodiment of an adapter for LED modules, according to the invention;

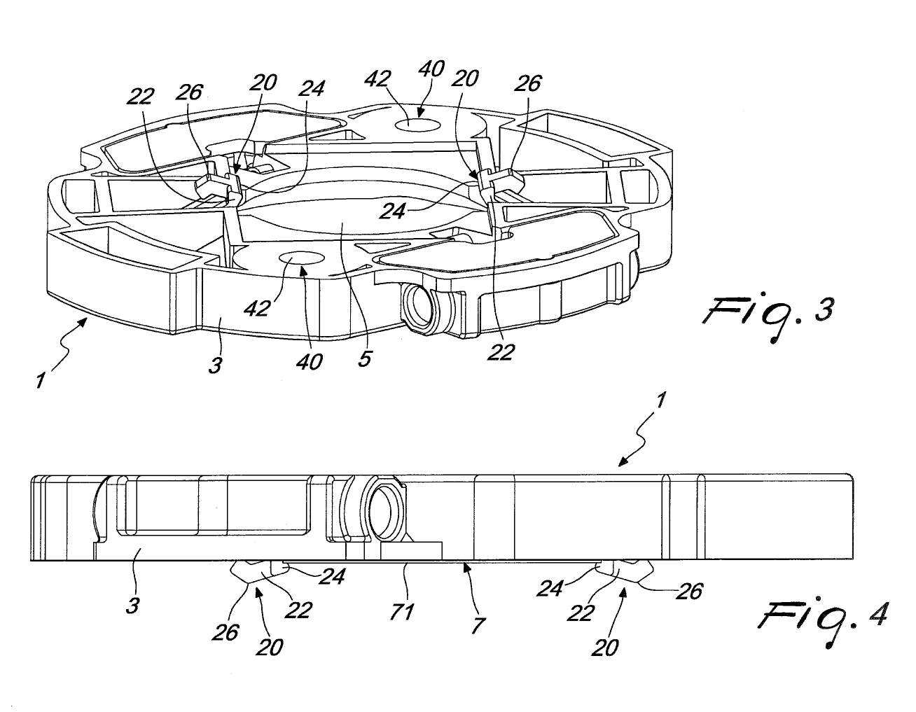

FIGS. 2 and 3 are perspective views from above of the adapter for LED modules of FIG. 1, arranged upside down, respectively with and without the LED module;

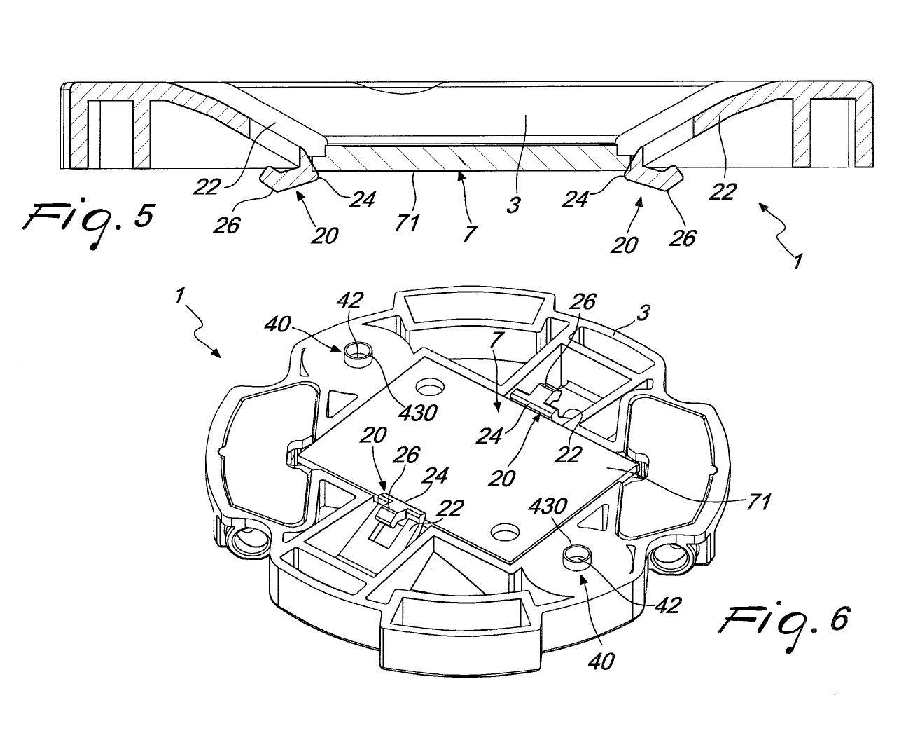

FIG. 4 is a side view of the adapter for LED modules of FIG. 1;

FIG. 5 is a sectional side view of the adapter for LED modules of FIG. 1;

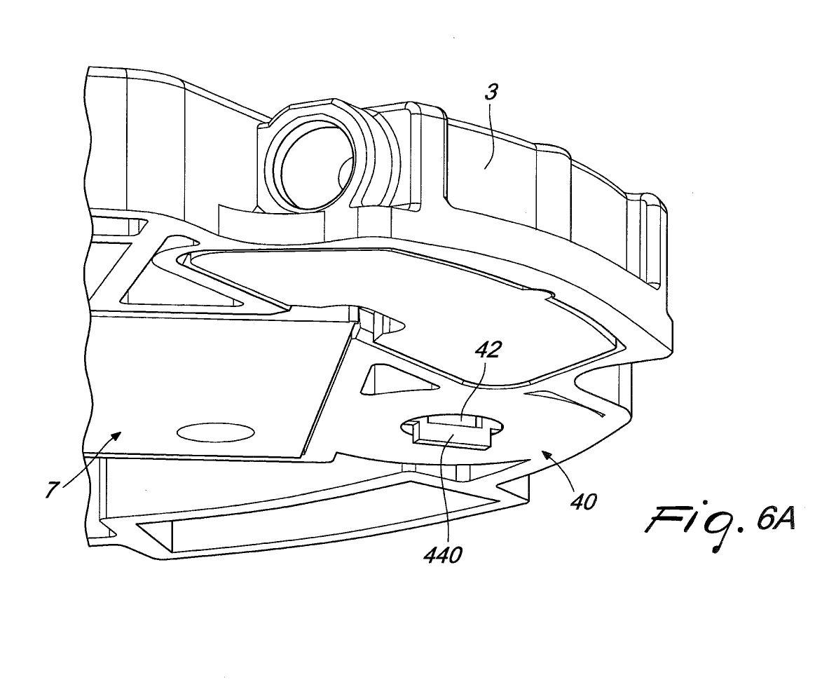

FIG. 6 is a perspective view from above of the adapter of FIG. 1, arranged upside down, in which a first type of centering means is visible;

FIG. 6A is a perspective view from above of the adapter of FIG. 1, arranged upside down, in which a variation of the first type of centering means is visible;

FIG. 7 is a perspective view from above of the adapter of FIG. 1, showing a second type of means for centering, which is performed by retaining the screws in the adapter body;

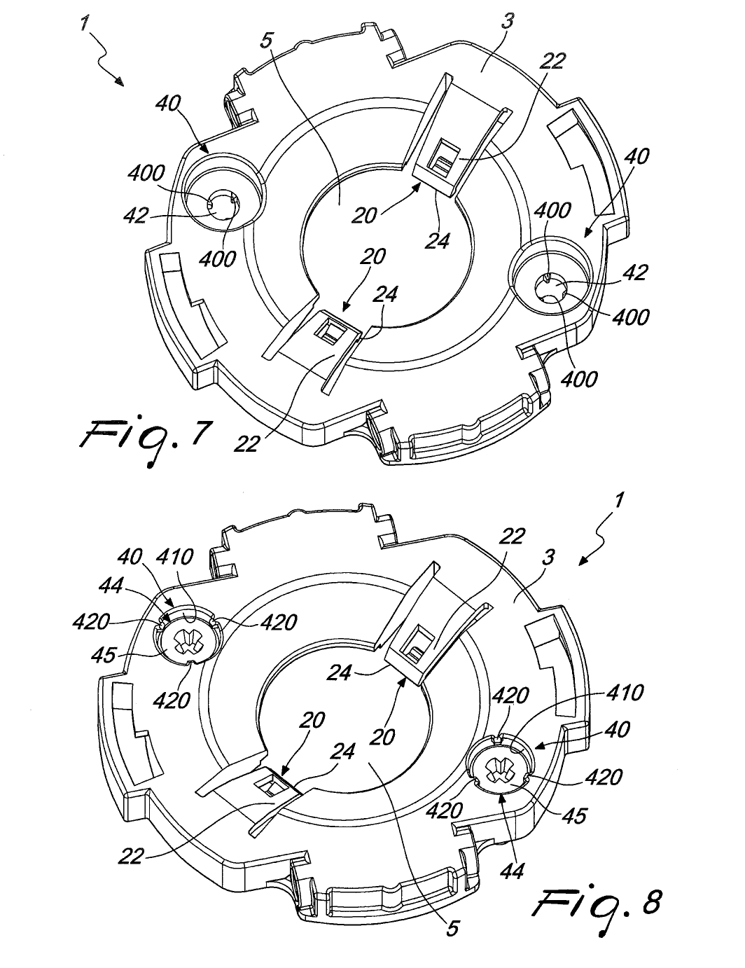

FIG. 8 is a perspective view from above of the adapter of FIG. 1, showing a third type of means for centering, which is performed by retaining the heads of the screws in the adapter body;

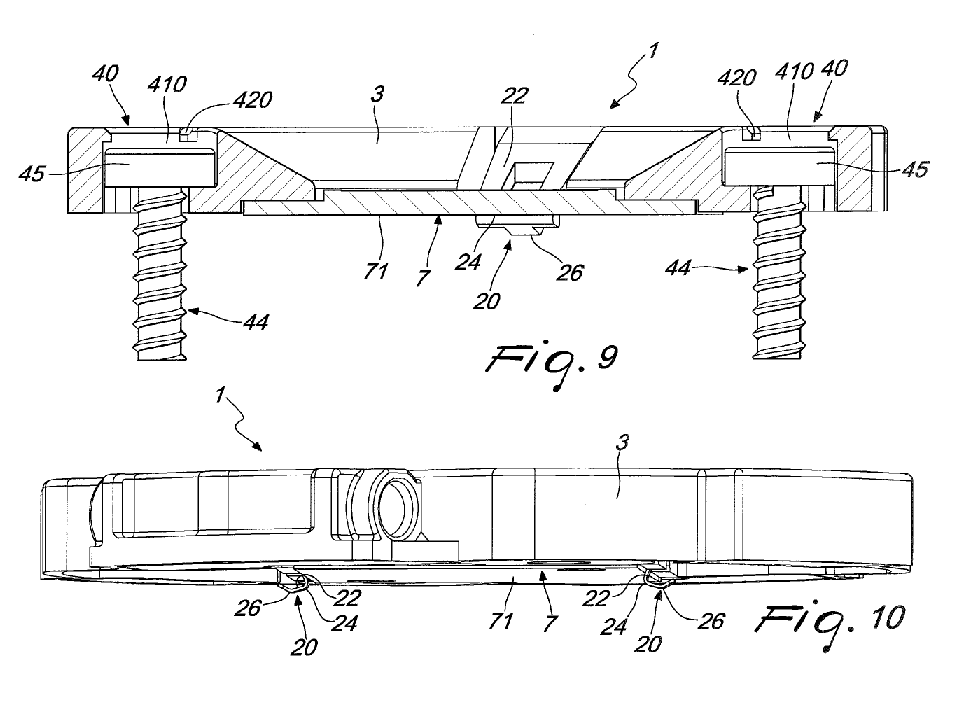

FIG. 9 is a side view of the adapter for LED modules of FIG. 8;

FIG. 10 is a perspective view from below of a first variation of the adapter for LED modules, according to the invention, with metallic means for retention of the LED module;

FIG. 11 is a perspective view from above of the adapter for LED modules of FIG. 10, arranged upside down;

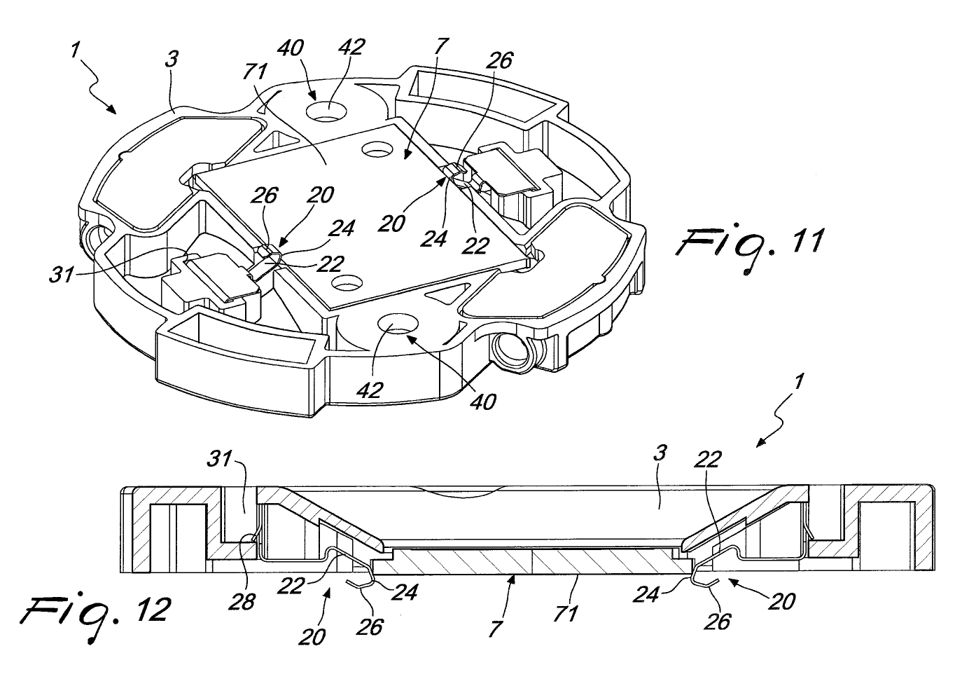

FIG. 12 is a sectional side view of the adapter for LED modules of FIG. 10;

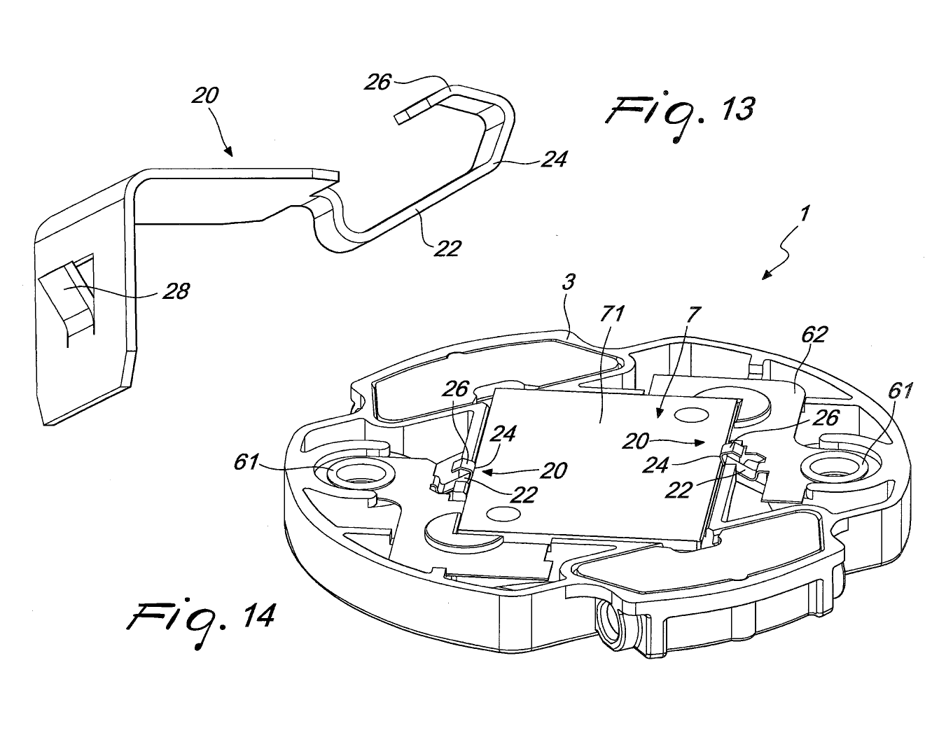

FIG. 13 is a perspective view of a first type of metallic retention means provided as independent component to be assembled to the adapter body;

FIG. 14 is a perspective view from above of a second variation of the adapter for LED modules of FIG. 10, arranged upside down, showing a second type of retention means with two separate metallic plates;

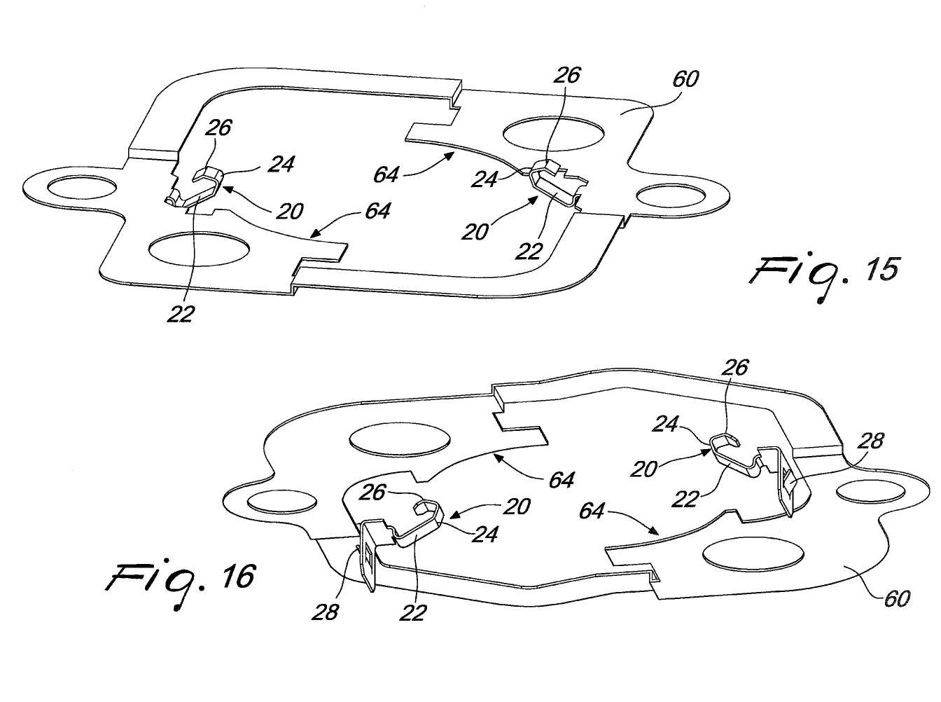

FIG. 15 is a perspective view of a third type of retention means, provided in one piece with the metallic plate;

FIG. 16 is a perspective view of a variation of the retention means and of the metallic plate with respect to those shown in FIG. 15, wherein the retention means and the metallic plate are separate elements;

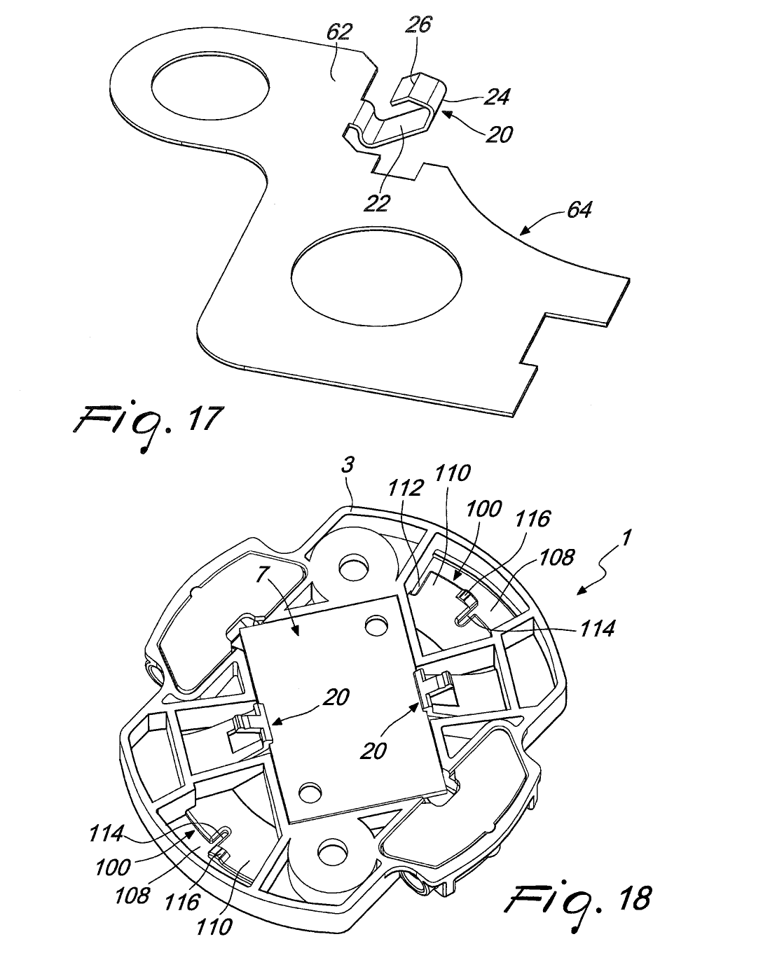

FIG. 17 is a perspective view of the retention means and of a metallic plate provided in two pieces;

FIG. 18 is a perspective view from above of an additional embodiment of the adapter according to the invention, arranged upside down;

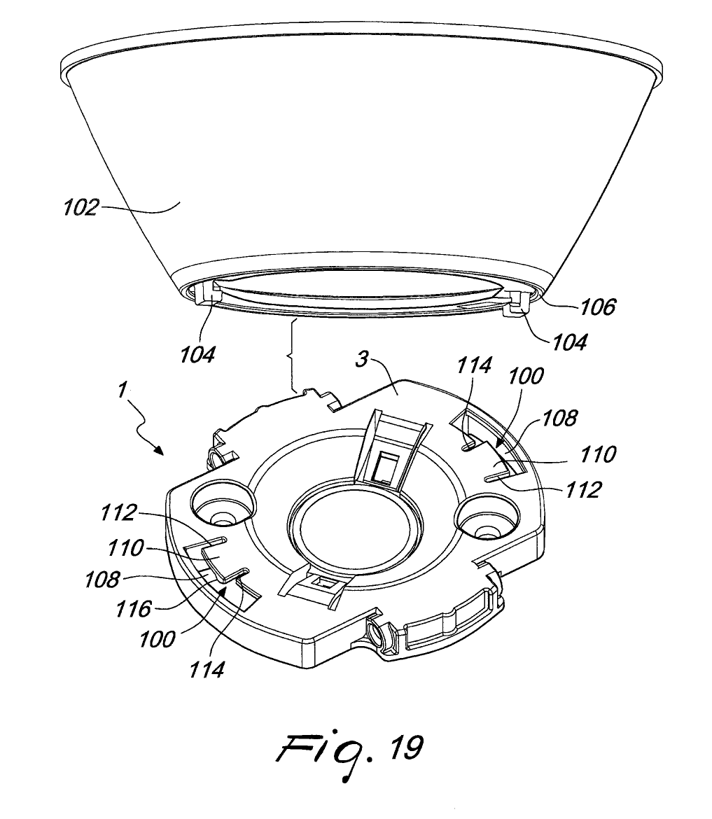

FIG. 19 is a perspective view from above of the adapter of FIG. 18, associated with a reflector;

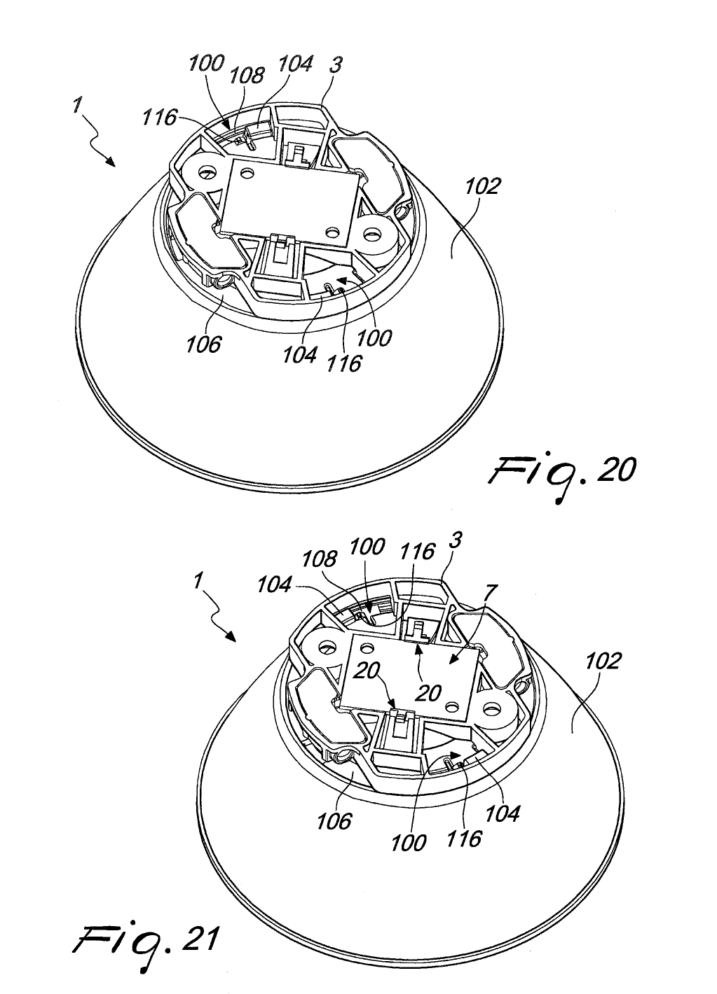

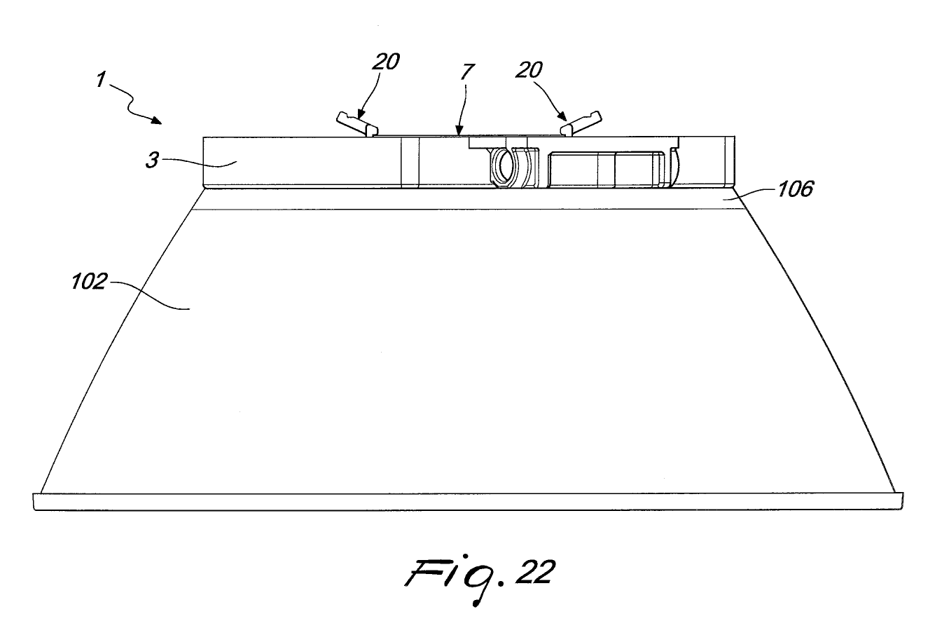

FIGS. 20 and 21 are views of two steps of the assembly of the reflector to the adapter of FIG. 18;

FIG. 22 is a side view of the adapter of FIG. 18, with the reflector assembled.

With reference to the cited figures, the adapter for LED modules, generally designated by the reference numeral 1, comprises an adapter body 3, for example made of plastic material, provided with a cavity 5 adapted to accommodate an LED module 7. The adapter body 3 can be coupled to a heat sink, which is not shown but is of a known type. Moreover, a heat dissipation interface element, not shown but of a known type, is insertable between the LED module 7 and the heat sink. The heat dissipation interface element can be of the adhesive type or can be constituted by a layer of grease or the like.

According to the invention, the adapter 1 comprises means 20 for retaining the LED module 7, which are adapted to engage the face 71 of the LED module 7 that is directed toward the heat sink, in order to retain the LED module 7 within the cavity 5.

In particular, said retention means 20 are adapted to retain the LED module 7 in the cavity 5 of the adapter body 3 in the configuration for assembling the adapter 1 to the heat sink, i.e., during the assembly step, and particularly when the adapter body 3 is handled with the LED module 7 directed downward and not yet fixed to the heat sink.

The adapter 1 may also comprise means 40 for centering the adapter body 3 with respect to the heat sink. These centering means 40, also, are adapted to ensure the centering of the adapter 1 with respect to the heat sink in the configuration for assembling the adapter 1 to the heat sink, i.e., during the assembly step.

The retention means 20 comprise advantageously at least two elastic retention arms 22 that have a first portion 24 adapted to engage the face 71 of the LED module 7, and a second portion 26, which is advantageously pointed and is adapted to abut against the heat sink. The abutment of the second portion 26 against the heat sink, during the assembly step, entails the elastic flexing of the retention arms 22, so that said first portion 24 is disengaged, rotating slightly on the tip defined by the second portion 26 that acts as a fulcrum, from the face 71 of the LED module 7, which can therefore rest completely on the heat sink, or optionally on the heat dissipation interface element, as will be explained better hereinafter.

The centering means 40 comprise, advantageously, at least two fixing holes 42 that are provided in the adapter body 3 and are adapted to allow the passage of at least two screws 44, shown in FIGS. 8 and 9, for fixing to a corresponding number of holes that are present, as is known, in the heat sink.

A first type of centering means 40 is shown in FIGS. 6 and 6A. Said means comprise, for each one of the holes 42, an insertion element 430, 440 that protrudes from the adapter body 3, from the side directed toward the heat sink. These insertion elements 430, 440 are adapted to enter the holes 42 for fixing the heat sink without preventing the subsequent insertion of the screws 44 for fixing the adapter body 3 to the heat sink. FIG. 6 shows two insertion elements 430 that are collar-shaped. The diameter of said collar is smaller than the diameter of the corresponding holes provided in the heat sink, so that the insertion of said collars in the fixing holes of the heat sink allows precise centering between the two components. Said collars do not prevent the insertion and screwing of the screws 44 through and past the hole 42; in fact the collar, once it has performed its centering task, can be stripped/pulled off due to the screwing of said screws 44 to the heat sink. The insertion element 440, as shown in FIG. 6A, may also be an element that occupies physically the internal part of the hole 42 and protrudes from the adapter body 3, from the side directed toward the heat sink. The insertion of the screws 44 may cause the breakage of the insertion element 440 once said insertion element has performed its centering function.

A second type of centering means 40 is shown in FIG. 7. Said means comprise a plurality of interference elements 400 that protrude toward the inside of the holes 42 and are adapted to interfere physically with the screws 44 in their threaded portion. In particular, said interference elements 400 occupy partially the passage section of the screws 44. In this manner it is possible to insert stably the screws 44 in the adapter body 3 before it is associated with the heat sink. The screws 44, due to the interference elements 400, tend to remain in the desired position of maximum insertion and therefore protrude from the adapter body 3 toward the part that is directed toward the heat sink. In this manner, the centering of the screws 44, and therefore of the adapter body 3 with respect to the holes of the heat sink, is facilitated.

A third type of centering means 40 is shown in FIGS. 8 and 9. Said means comprise at least two seats 410 for the heads 45 of the screws 44 and comprise a plurality of elements 420 for retaining the heads 45 that protrude toward the inside of said seats 410. Such retention elements 420 are advantageously constituted by flexible protrusions adapted to allow the snap insertion of the head 45 of the screw 44 and prevent instead its exit. Advantageously, these protrusions have an upper face that is slightly inclined downward, in order to facilitate the insertion of the head 45 of the screw 44 in the seat 410, and a lower face that is at right angles to the lateral walls of the seat 410, in order to prevent the exit of the head 45 of the screw 44 from the seat 410.

The screws 44 therefore protrude from the adapter body 3 from the part directed toward the heat sink. In this manner the centering of the screws 44 and therefore of the adapter body 3 with respect to the holes of the heat sink is facilitated.

The retention arm 22 may be provided directly in the adapter body 3 and therefore be made of a material such as plastics, as shown in FIGS. 1 to 9, or, according to first and second variations of the adapter 1, the arm 22 may be made of a material such as metal, as shown in FIGS. 10 to 16.

In particular, the arm 22 may be part of a metallic structure that can be inserted by snap action, due to a retention hook 28, in a seat 31 provided in the adapter body 3, as shown in FIGS. 11, 12 and 13.

The adapter 1, moreover, may comprise a metallic plate 60, 62, as shown in FIGS. 14 to 17, which is rendered integral with the adapter body 3 and is adapted to support the LED module 7 in the cavity 5, particularly when it is associated in one piece with the retention arm 22. Such plate 60, 62 may be a plate 60 provided in one piece, as shown in FIGS. 15 and 16, or a plate 62 provided in two parts, as shown in FIGS. 14 and 17. Said plate 60, 62 is advantageously fixed to the adapter body 3 by means of metallic rivets 61 or simply accommodated in the adapter body 3. The LED module can therefore rest advantageously on the metallic plate 60, 62 instead of resting directly on the adapter body 3.

Advantageously, the retention means 20 may be provided directly in the metallic plate 60, 62, as shown in FIGS. 14, 15 and 17. As an alternative, the metallic plate 60, 62 and the retention means 20 may be separate and independent components, as shown in FIG. 16.

Moreover, the portions of the plate 60, 62 designated by the reference numeral 64 can be folded downward, so that, by spring action, they push directly the upper part of the LED module 7 toward the heat sink in order to ensure stability over time with respect to variations over time due to shrinkages or expansions of the several components and ensure a pressure on the LED module 7 that is substantially constant over time.

In the additional embodiment of the adapter 1, shown in FIGS. 18 to 22, the adapter 1 comprises engagement means 100 for a reflector 102. Systems for engaging a reflector with an adapter for LED modules of the package/array type of the known type comprise generally an L-shaped tab that protrudes from the base of the reflector, and a seat for the insertion of said tab, provided in the adapter body. The seat is generally occupied partially by a protrusion, so that the L-shaped tab of the reflector can be inserted in the seat of the adapter body and, by means of a small rotation of the reflector, the L-shaped tab engages the protrusion defined in the seat. However, this is not enough to ensure a stable engagement between the reflector and the adapter, and in fact, in adapters of the know type, it is necessary to provide also a system for preventing the disengagement of the reflector. This disengagement prevention system is generally constituted by a protrusion that protrudes from the base of the reflector and interferes, by means of said small rotation, with an adapted seat formed in the adapter body. Therefore, in adapters of the known type generally there is a reflector engagement system that, for correct operation, must cooperate with a system for preventing disengagement of said reflector, in order to prevent its unintentional separation.

As shown in FIGS. 18 to 22, the adapter 1 comprises means 100 for engaging a reflector 102. The engagement means 100 comprise at least one tab 104 that is L-shaped and protrudes axially from the base 106 of the reflector 102, and a seat 108 that is provided in the adapter body 3 for the insertion of the tab 104. The adapter body 3 comprises, moreover, a protruding portion 110 that protrudes partially inside the seat 108 and is flanked by two slots 112, 114. The protruding portion 110 comprises a protrusion 116. The tab 104 of the reflector 102 is insertable in the seat 108 and engages the protruding portion 110 by means of a rotation of the reflector 102 with respect to its own central axis, such as to allow the tab 104 to move beyond the protrusion 116. The protrusion 116 is adapted to keep the tab 104 engaged with the protruding portion 110.

In particular, FIG. 20 shows a first position of assembly of the reflector 102 to the adapter 1. In this position the tab 104 is inserted in the seat 108 and particularly in the portion of the seat 108 that is not engaged by the protruding portion 110. The rotation of the reflector 102, shown in FIG. 21, with respect to its own central axis entails that the tab 104 moves beyond the protrusion 116 and engages the protruding portion 110, so that the reflector 102 is fixed to the adapter body 3. In fact, an accidental opposite rotation of the reflector 102 is prevented indeed by the protrusion 116, which ensures that the tab 104 remains in the position for engagement with the protruding portion 110, as shown in FIG. 21.

Advantageously, the adapter 1 comprises at least two seats 108, with the respective protruding portions 110, for engagement with at least two tabs 140 defined in the reflector 102.

The reflector 102 can be provided without any additional protrusions, as occurs in the case of the background art, because the rotation-preventing system is integrated in the protruding portions 110 with the protrusions 116, which make the unwanted and accidental release of the reflector 102 from the adapter body 3 even more difficult.

The slots 112, 114 have the function of rendering the protruding portion 110 elastic, and said portion can therefore be deformed slightly during the insertion of the tab 104 by means of the rotation of the reflector 102 and particularly during movement beyond the protrusion 116 on the part of the tab 104, to then return to the initial configuration once the position for fixing the reflector 102 to the adapter 1, shown in FIG. 21, has been reached.

With respect to reflector engagement systems of the known type, the fixing means of the adapter according to the invention allow a fixing of the reflector that is safer and less subject to accidental releases.

The main operations for assembling an LED module to a heat sink by means of the adapter 1 for LED modules will be described hereinafter.

The LED module 7 is retained in the cavity 5 of the adapter body 3 by way of the retention means 20. In this configuration it is possible to move the adapter 1 that retains in a stable and fixed manner the LED module 7 closer, from below, to the surface of the heat dissipation interface element or to the heat sink.

The centering means 40 also operate in this approach step and allow to center conveniently the adapter 1 with respect to the heat sink. Said centering means 40, in all of their variations, allow to move the adapter 1 closer to the heat sink, centering it, without however bringing the LED module 7 into contact with the optional heat dissipation interface element, constituted by an adhesive layer or by a layer of grease or the like.

Moreover, the retention means 20 that protrude from the adapter body 3 in the part that is directed toward the heat sink, during said approach, touch, only with the second portions 26, the surface of the heat sink, where the heat dissipation interface element is located, keeping the LED module 7 spaced from said element.

During the tightening of the screws 44, however, the tips of the portions 26 in contact with the heat sink tend to create a torque that acts on the retention arms 22 and to move away the first portions 24, which retain the face 71 of the LED module 7, allowing said face 71 to move closer to the heat dissipation interface element and to make contact with it.

In other words, both the centering means 40 and the retention means 20 cooperate in keeping the LED module 7 spaced from the heat dissipation interface element and from the heat sink, up to the moment when the screws 44 are tightened. This allows to prevent the LED module 7 from becoming attached to the heat dissipation interface element during the centering step.

Usually, the mechanical pressure is transmitted by the screws 44 to the LED module 7 by means of the adapter body 3, which is made of a material such as plastics. The addition of the metallic plate 60 allows to distribute more uniformly and reliably the mechanical pressure that the screws 44 transmit to the LED module 7, since said metallic plate 60 is interposed between the adapter body 3 and said screws 44; therefore, the metallic plate 60, and not the adapter body 3, pushes, with or without spring-loaded folded portions 64, the LED module 7 against the heat sink.

Once assembly of the heat sink to the adapter 1 has been performed, it is possible to engage, by way of the engagement means 100, the reflector 102 with the adapter body 3, by means of the simple insertion of the tab 104 in the seat 108 and the slight rotation of the reflector 102 with respect to its own central axis.

In practice it has been found that the adapter for LED modules, according to the present invention, achieves the intended aim and objects, since it allows to facilitate considerably its assembly to a heat sink, ensuring at the same time a more stable and reliable assembly over time.

Another advantage of the adapter, according to the invention, resides in that it eliminates the known problems of centering thereof with respect to the heat dissipation interface elements, avoiding unwanted damage to this material.

A further advantage of the adapter, according to the invention, resides in that it ensures over time the reliability and resistance thereof, by means of the redistribution of the mechanical pressures thanks to the adoption of the metallic plate, with or without the spring-loaded parts, and also prevents tolerance problems due to any shrinkages of materials such as plastics of which the adapter is made or of the other components.

Another advantage of the adapter, according to the invention, resides in that the retention means of the LED module do not act simply on the lateral thickness of the LED module but engage directly with the lower face thereof, preventing any type of horizontal movement that can move the LED module out of its seat and/or away from the axis with respect to the cavity and the fixing holes.

The adapter for LED modules of the package/array type thus conceived is susceptible of numerous modifications and variations, all of which are within the scope of the appended claims.

All the details may further be replaced with other technically equivalent elements.

In practice, the materials used, so long as they are compatible with the specific use, as well as the contingent shapes and dimensions, may be any according to requirements.

The disclosures in Italian Patent Application No. MI2013A000843 from which this application claims priority are incorporated herein by reference.

1-11. (canceled)

12. An adapter for LED modules of the package/array type, comprising an adapter body that is provided with a cavity adapted to accommodate an LED module of the package/array type and is associable with a heat sink, a heat dissipation interface element being insertable between said LED module and said heat sink, further comprising retention means for retaining said LED module, which are adapted to engage the face of said LED module that is directed toward said heat sink, in order to retain said LED module within said cavity.

13. The adapter for LED modules of the package/array type, according to claim 12, further comprising means for centering said adapter body with respect to said heat sink.

14. The adapter for LED modules of the package/array type, according to claim 12, wherein said retention means comprise at least two elastic retention arms that have a first portion adapted to engage said face of said LED module, and a second portion or tip that is adapted to abut against said heat sink, the abutment of said second portion or tip against said heat sink flexing elastically said retention arms and disengaging said first portion from said face of said LED module.

15. The adapter for LED modules of the package/array type, according to claim 13, wherein said centering means comprise at least two fixing holes that are provided in said adapter body and are adapted to allow the passage of at least two screws for fixing to a corresponding number of holes in said heat sink, said centering means comprising a plurality of elements for interference with said at least two screws, said elements protruding toward the inside of said at least two holes.

16. The adapter for LED modules of the package/array type, according to claim 13, wherein said centering means comprise at least two fixing holes that are provided in said adapter body and are adapted to allow the passage of at least two screws for fixing to a corresponding number of holes in said heat sink, said centering means comprising at least two seats for the heads of said at least two screws, and comprising a plurality of elements for retaining said heads, said elements protruding toward the inside of said at least two seats.

17. The adapter for LED modules of the package/array type, according to claim 13, wherein said centering means comprise at least two fixing holes that are provided in said adapter body and are adapted to allow the passage of at least two screws for fixing to a corresponding number of holes in said heat sink, said centering means comprising, for each one of said at least two holes, and protruding from said adapter body, an insertion element, which is adapted to enter said holes of said heat sink, said insertion element allowing the insertion of said at least two screws in said at least two holes in order to allow the fixing of said adapter body to said heat sink.

18. The adapter for LED modules of the package/array type, according to claim 12, further comprising a metallic plate that is integral with said adapter body and is adapted to support said LED module in said cavity of said adapter body and to apply a substantially constant pressure of said LED module against said heat sink.

19. The adapter for LED modules of the package/array type, according to claim 12, wherein said retention means are provided in said metallic plate.

20. The adapter for LED modules of the package/array type, according to claim 12, wherein said retention means can be inserted by snap action in a seat provided in said adapter body.

21. The adapter for LED modules of the package/array type, according to claim 13, wherein said retention means and said centering means are adapted to keep said LED module spaced from said heat sink during the step of approach and centering of said adapter with respect to said heat sink in order to prevent said LED module from making contact with said heat dissipation interface element.

22. The adapter for LED modules of the package/array type, according to claim 12, further comprising engagement means for fixing a reflector, said engagement means comprising at least one tab that is L-shaped and protrudes axially from a base of said reflector and a seat that is provided in said adapter body for the insertion of said tab, said adapter body comprising a portion that protrudes partially inside said seat that is flanked by two slots, said protruding portion comprising a protrusion, said tab of said reflector being insertable in said seat and engaging said protruding portion by means of a rotation of said reflector with respect to its central axis, such that said tab moves beyond said protrusion, said protrusion being adapted to keep said tab engaged with said protruding portion of said adapter body.
